(19) United States
(12) Patent Application Publication
(10) Pub. No.: US 2026/0079776 A1
(43) Pub. Date: Mar. 19, 2026

(54) METHOD OF CALIBRATING A PHYSICAL UNIT AND SYSTEM FOR CALIBRATING AND ADJUSTING A PHYSICAL UNIT

(71) Applicant: Buerkert Werke GmbH & Co. KG, Ingelfingen (DE)

(72) Inventor: Anne MÄRZ, Ingelfingen (DE)

(21) Appl. No.: 19/331,021

(22) Filed: Sep. 17, 2025

(30) Foreign Application Priority Data
Sep. 19, 2024 (EP) 24 201 436.3

(51) Int. Cl. G06F 11/00

(52) U.S. Cl. CPC G06F 11/004; G06F 2201/81

(57) ABSTRACT

A method of calibrating a physical unit and a system for calibrating and adjusting a physical unit. The physical unit is arranged in a real process environment. A virtual component is provided in a virtual process environment formed to correspond to the real process environment so that the physical unit behaves in a manner corresponding to the virtual component. A measurement is performed with the physical unit to obtain a real measured value. A measurement is simulated with the virtual component to obtain a virtual measured value. An offset is determined by a verification unit based on a comparison of the real and virtual measured values. The real and virtual measured values are corresponding. The physical unit is calibrated by the verification unit using the offset at least such that compensation data based on the offset is taken into account for future measured values of the physical unit.

### FIELD OF THE DISCLOSURE

Embodiments of the present disclosure relate to a method of calibrating a physical unit and to a system for calibrating and adjusting a physical unit.

### BACKGROUND

To obtain accurate and reliable measured values, physical units, such as measuring units, must be calibrated or adjusted either in a time-based or event-based manner. Time-based calibration can be performed at regular intervals or at discrete points in time. Event-based calibration, on the other hand, can depend on a detected difference between an actual value of the physical unit and the associated set value. If the difference becomes too large, calibration can be triggered. Event-based calibration can also be triggered by an external occurrence, for example an ambient temperature, a pressure ratio, or by manual operation.

In this context, calibration refers to a comparison and/or alignment with a physical reference for the physical unit which specifies the set value. The degree to which the measured values recorded with the physical unit differ from the measured values obtained with the physical reference is then determined.

Adjustment refers to intervention in the device to increase the accuracy of the measurements. This can be done through maintenance work and/or by entering updated operating parameters which have a direct impact on how the measured values are recorded, as a result of which accuracy is increased. For example, adjustment is necessary due to aging processes of the physical unit or due to significantly changing external environmental conditions.

According to previous approaches, it is necessary to remove the physical unit from the underlying plant, which is, for example, part of a process environment, so that the physical unit can be compared with the physical reference at a common location under the same conditions. This usually results in a shutdown of the plant or at least a limited operability of the plant, which reduces the efficiency of the plant.

Accordingly, there is a need to increase the efficiency of the plant.

### SUMMARY

According to the present disclosure, a method of calibrating a physical unit (physical device) is provided. The physical unit is arranged in a real process environment, for example in a plant such as a process plant. The method comprises at least the following steps.

A virtual component, also called virtual representation, is provided which is formed in a virtual process environment. The virtual component is therefore provided in digital form, which is why the virtual component may also be referred to as a digital component. The virtual process environment is formed to correspond to the real process environment so that the physical unit arranged in the real process environment behaves in a manner corresponding to the virtual component in the virtual process environment. In this respect, the real process environment is virtually modeled to obtain the virtual process environment. In other words, the virtual process environment represents a virtual replica of the real process environment.

A real measurement is performed with the physical unit in the real process environment to obtain a real measured value.

A measurement with the virtual component in the virtual process environment is simulated to obtain a virtual measured value. The virtual measured value is therefore a simulated measured value of the virtual component in the virtual process environment.

An offset is determined by a verification unit based on a comparison of the real measured value and the virtual measured value. The real measured value corresponds to an actual value of the physical unit, whereas the virtual measured value is a set value for the physical unit. The verification unit thus performs a comparison between the actual value and the set value to determine the deviation, i.e., the offset. The offset is then used to determine the compensation data specifying how the real measured values are to be interpreted in relation to the set values. The real measured value and the virtual measured value correspond to each other. In other words, the real measured value (actual value) is compared with the assigned virtual measured value (set value).

The physical unit is calibrated by the verification unit using the offset at least such that compensation data based on the offset is taken into account for future measured values of the physical unit. Based on the deviation determined, i.e., the offset, compensation data is determined and taken into account at least for future measured values of the physical unit. In addition, the compensation data may also be used to subsequently correct measurement values already obtained from the physical unit. In any case, the correction allows more accurate measurement values of the physical unit to be obtained.

Therein and in the following, the term “unit” is understood to describe suitable hardware, or a combination of hardware and software that is configured to have a certain functionality. The hardware may, inter alia, comprise a CPU, a GPU, an FPGA, an ASIC, or other types of electronic circuitry.

The method is based on the findings that it is possible to design a virtual process environment which is corresponding to the real process environment, i.e., is a replica of the real process environment. The virtual component which is corresponding to the physical unit exhibits a temporal behavior which corresponds to the temporal behavior of the physical unit.

Even if the virtual component in the virtual process environment generally behaves in a manner corresponding to the physical unit in the real process environment, unknown influencing factors having an effect on the physical unit may occur, such as unpredictable changes in the environmental conditions, which lead to a deviation between the temporal behavior of the physical unit and the temporal behavior of the virtual component. Effects caused by aging or wear of the physical unit which are not taken into account in the virtual component may also lead to deviations. The real measured values obtained using the physical unit then generally do not match the virtual measured values simulated using the virtual component, resulting in the deviation.

The compensation data does not have to be written to the physical unit, but can be taken into account by a device connected to the physical unit, an evaluation device, for example. In particular, this makes it possible to avoid adjusting the physical unit, i.e., installing updated operating parameters or performing maintenance work on the physical unit, at least for a certain period of time, as a result of which the efficiency of the physical unit and thus that of the plant in which the physical unit is used is increased.

The essential advantage of the method is that the physical unit or the plant in which the physical unit is provided remains operational without restriction, i.e., does not have to be interrupted.

The physical unit may have a measuring unit, in particular a sensor or a sensor-actuator system, e.g., a mass flow controller. The physical unit may also be a field device which includes a corresponding measuring unit.

In (process engineering) plants, a large number of such physical units are often implemented, so that the method enables a significant increase in efficiency, since the method is applicable to all of the physical units. In this respect, the plant does not have to be at least partially deactivated for the calibration of the physical units.

The real process environment refers to the actual environment in which the physical unit is arranged, i.e., in the plant, for example in a factory. The real process environment has environmental characteristics prevailing in the vicinity of the physical unit, which influence the mode of operation of the physical unit, such as a temperature, a pressure, lighting conditions, substances, electromagnetic interference fields, and other environmental parameters. The various influencing factors affect the mode of operation of the physical unit over time. In particular, the physical unit may exhibit time-varying behavior due to the environmental characteristics.

The virtual process environment recreates the real process environment so that the environmental characteristics prevailing in the real process environment are simulated in the virtual process environment for the virtual component. This results in the virtual component exhibiting a behavior which recreates the effects of the environmental characteristics of the real process environment. In other words, the virtual process environment can be regarded as a simulation of the real process environment.

Generally, a physical reference may be assigned to the physical unit. The physical reference is arranged in a real laboratory environment, which is why the physical reference is also referred to as a real reference. Unlike in the real process environment, defined and consistent environmental conditions prevail in the real laboratory environment. This means that the real process environment differs from the real laboratory environment. The physical reference issues the correct value at all times.

The physical reference differs from the physical unit in particular with regard to measurement precision. The physical reference generally has a measurement precision which is at least ten times higher than the measurement precision of the physical unit.

The virtual component may be indirectly or directly compared with the physical reference for the physical unit, as a result of which the high accuracy of the physical reference for the virtual component is used, which is then used to calibrate the physical unit by means of the virtual component. Since the virtual component is used for calibration, it is not necessary to remove the physical unit and/or the physical reference from their respective environments.

One aspect provides that the virtual component is a virtual reference which is modeled on a physical reference assigned to the physical unit. The physical reference is arranged in the real laboratory environment. In contrast thereto, the virtual reference is arranged in the virtual process environment. The real process environment differs from the real laboratory environment, as already explained above.

In this configuration of the method, the virtual reference has the characteristics of the physical reference for the physical unit, i.e., in particular, the higher measurement accuracy of the physical reference compared with the physical unit. The physical unit is then calibrated directly based on the virtual reference. In this respect, the virtual reference differs from the physical reference only in terms of their respective environments, since the virtual reference is provided in the virtual process environment, i.e., the environment corresponding to the real process environment in which the physical unit is provided. In contrast thereto, the physical reference is provided in the real laboratory environment, which differs from the real process environment.

The behavior of the physical reference in the real process environment is therefore simulated by the virtual reference in the virtual process environment. Since the real process environment has environmental conditions which differ from those of the real laboratory environment, the physical reference in the real process environment behaves differently from a behavior of the physical reference in the real laboratory environment. Therefore, the behavior of the physical reference in the environment in which the physical unit is located is simulated.

The behavior of the physical reference in the real process environment is modeled. In the simulation, an environment offset may be taken into account which reflects the change in environment between the real laboratory environment and the real process environment.

Accordingly, the virtual reference in a virtual laboratory environment modeled on the real laboratory environment would behave in a manner corresponding to the physical reference in the real laboratory environment.

Taking the additional environment offset between the virtual laboratory environment and the virtual process environment into account, the behavior of the virtual reference of the virtual process environment may then be determined, which in this respect corresponds to the behavior of the physical reference in the real process environment, which is why calibration of the physical unit is possible. The environment offset may be determined based on the environmental conditions between the real process environment and the real laboratory environment, for example by the verification unit. Alternatively, the environment offset may of course also be determined by another device and then transmitted to the verification unit.

In another embodiment of the method, the virtual component is a virtual unit which is modeled on the physical unit. The virtual component is therefore a digital twin of the physical unit. The virtual unit is formed in the virtual process environment so that the virtual unit formed in the virtual process environment behaves in a manner corresponding to the physical unit arranged in the real process environment. In the end, the virtual component in this embodiment of the method is a simulation of the physical unit. Since the virtual process environment is modeled on the real process environment, the virtual unit behaves in a manner corresponding to the physical unit. Due to the corresponding behavior of the virtual unit and the physical unit, the virtual unit may in this case be used with little effort to calibrate the physical unit.

For example, in this configuration of the method, a virtual reference is additionally provided, which is modeled on a physical reference assigned to the physical unit. As already explained above, the physical reference is arranged in the real laboratory environment, whereas in this case, the virtual reference is arranged in a virtual laboratory environment which is formed to correspond to the real laboratory environment. The real process environment differs from the real laboratory environment. Two virtual components are thus simulated, namely the virtual unit and the virtual reference. The respective environments of the virtual components represent replicas of the real environments of the associated physical components. The virtual unit is arranged in the virtual process environment, which is a replica of the real process environment in which the physical unit is provided, whereas the virtual reference is arranged in the virtual laboratory environment, which is a replica of the real laboratory environment in which the physical reference is provided. In other words, a corresponding digital twin which is provided in a simulated replica of the environment of the physical component is generated for the two physical components.

In particular, the virtual reference in the virtual laboratory environment behaves in a manner corresponding to the physical reference in the real laboratory environment. This reduces the simulation effort for the virtual reference compared to the embodiment in which the virtual reference is arranged in the virtual process environment.

Optionally, before calibrating the physical unit by means of the virtual unit, the verification unit compares the virtual unit with the virtual reference. In particular, the verification unit verifies whether the virtual unit matches the virtual reference. If this is not the case, calibration is performed such that first the virtual unit is calibrated with the virtual reference arranged in the virtual laboratory environment. The virtual unit calibrated in this way can then be used to calibrate the physical unit arranged in the real process environment.

In other words, virtual calibration may be performed by determining compensation data for the virtual unit based on the virtual reference. The compensation data may be calculated as already explained above. The physical unit may then be calibrated in a simple manner by simply applying or installing the compensation data already determined previously, provided that a deviation between the physical unit and the virtual unit has been detected. In other words, only synchronization between the physical unit and the virtual unit takes place, since the virtual unit has already been calibrated using the virtual reference and is therefore in a calibrated state.

Furthermore, the verification unit may compare the virtual reference, in particular before calibrating the physical unit by means of the virtual unit, with the physical reference. The verification unit thus checks reference set values specified by the physical reference against virtual reference actual values of the virtual reference. If the verification unit detects a reference offset between the physical reference values of the physical reference, i.e., the reference set values, and the virtual reference values of the virtual reference, i.e., the reference actual values, the verification unit determines reference compensation data based on the reference offset, which is then taken into account when interpreting the virtual reference values of the virtual reference. As already explained above, an environment offset may also be taken into account here if the virtual reference is arranged in the virtual process environment instead of the virtual laboratory environment.

The verification unit may compare the virtual reference with the physical reference at temporally regular time intervals. The appropriate time intervals may be determinable by a user input.

According to one aspect, the verification unit takes an environment offset which depends on the virtual laboratory environment of the virtual reference into account. The environment offset allows the behavior of the virtual reference to be selectively simulated in the virtual process environment or in the virtual laboratory environment. In particular, the environment offset makes it possible to use the virtual component as a virtual reference in the virtual process environment, simulation of the virtual unit thus being unnecessary.

In some embodiments, the verification unit calibrates the physical unit with the virtual component if an event-and/or time-based trigger condition is fulfilled.

The event-based trigger condition relates in particular to the offset between a real measured value and a corresponding virtual measured value. In this case, the verification unit compares the offset between the real measured value and the virtual measured value with a difference threshold value. If the amount of the offset is greater than the amount of the difference threshold value, the process is triggered. The verification of the offset may be performed by the verification unit at regular time intervals or at discrete points in time.

Optionally, the difference threshold value may be determinable, in particular adjustable. For example, the difference threshold value may be set by a maintenance person as required. The event-based trigger condition ensures that the calibration effort is reduced, as calibration only needs to be carried out when necessary.

Alternatively, the event-based trigger condition may also comprise a user input, i.e., manual triggering.

Furthermore, the event-based trigger condition may be based on an external occurrence, e.g., an ambient temperature and/or a pressure ratio.

The time-based trigger condition relates to calibration of the physical unit at temporally predeterminable time intervals. The time intervals may be adapted and set by a maintenance person. This means that calibration is performed independently of the aforementioned offset. The time-based trigger condition ensures continuous calibration of the physical unit.

This means that the verification unit triggers the calibration of the physical unit with the virtual component:
at regular, predeterminable time intervals, and/or
when the verification unit determines that the offset is greater or less (depending on the sign) than a predetermined threshold value, and/or
in response to a user input.

In particular, it is provided that calibration must be performed at the regular, predeterminable time intervals, but also when a corresponding event occurs, i.e., when a user input is made or the amount of the offset is greater than the threshold value.

In some embodiments, the virtual component is supplied with data from the physical unit to obtain virtual measured values. The data may be input data from the physical unit. This means that the input data on the basis of which the real measured values are obtained are also used for the virtual component. This ensures an identical data basis for the physical unit and the virtual component, which without deviating process conditions, should generally lead to a real measured value corresponding to the simulated virtual measured value.

Adjustment of the physical unit may be performed if the calibration of the physical unit still results in an offset. The verification unit can detect whether the calibration of the physical unit still results in an offset by determining a new (updated) offset within a predetermined time interval after the compensation data has been determined and applied, which is in particular greater than a predetermined difference threshold value. In other words, after calibration of the physical unit, it is assumed that the determined offset does not exceed or fall below a predetermined difference threshold value at least for a determined time interval (depending on the sign). If this condition is not fulfilled, the physical unit must be adjusted. In this case, the verification unit may issue an appropriate notification to the user that an adjustment of the physical unit is necessary.

In particular, the adjustment includes the installation of at least one new parameter and/or a manual adjustment of the physical unit in the real process environment. The manual adjustment of the physical unit may include a maintenance measure. The installation of at least one new parameter can be carried out as part of a firmware update.

In one embodiment of the method, the verification unit issues a notification or a message if calibration of the physical unit using the virtual component fails. The fact that calibration of the virtual component fails may have several reasons, in particular that:
the verification unit determines that, after determining the appropriate compensation data, a non-negligible offset (greater than/less than a specified difference threshold value) is detected again within a specified time interval, and/or
the virtual reference assigned to the physical unit cannot be reached, and/or
the virtual reference assigned to the virtual unit issues an error message, and/or
the virtual unit does not exist or cannot be reached, and/or
the virtual unit issues an error message.

This allows various configurations to be taken into account which prevent the physical unit from being calibrated with the virtual component.

For example, if the calibration of the physical unit with the virtual component fails, the verification unit issues the notification or message that the physical unit must be calibrated with a physical reference arranged in a real laboratory environment. It is therefore also possible to indicate what action needs to be taken to perform calibration of the physical unit.

Optionally, the verification unit issues a notification or message after successful calibration of the physical unit. The information about the calibration may then be processed further, in particular by the verification unit. The time interval for time-based calibration may be restarted.

In principle, the notification can be issued to a user who must then become at least partially active, whereas the message is intended for automated processing of the information about the calibration that has been performed. For example, in automated processing, a subsequent process can be started automatically.

According to one aspect, the verification unit is coupled to a data memory in which the determined compensation data from the verification unit is stored. A component which receives the real measured values of the physical unit during operation may then read the compensation data from the data memory and use it to interpret the real measured values so that the real measured values are calibrated based on the previously determined compensation data. This enables adjusted, reliable measured values without the need to intervene in the physical unit.

According to a further aspect, the present disclosure also relates to a computer program product comprising instructions which, when the computer program product is executed by a processor, cause the latter to execute at least part of the method described above, in particular the measurement, simulation, and calculation steps. The advantages achieved by the method described herein are also achieved accordingly by the computer program product.

According to an additional aspect, the present disclosure also relates to a computer-readable storage medium comprising instructions which, when the computer program product is executed by a processor, cause the latter to execute at least part of the method described above, in particular the measurement, simulation and calculation steps. The advantages achieved by the method described herein are also achieved accordingly by the computer-readable storage medium.

According to a further aspect, the object is achieved according to the present disclosure by a system for calibrating and adjusting a physical unit. The system has a real process environment in which the physical unit is arranged. The system has at least one processor which is set up to simulate a virtual process environment which is formed to correspond to the real process environment and in which a virtual component is provided. The system is set up to execute the method described above.

The advantages achieved by the method are also achieved accordingly by the system. In particular, the efficiency of the physical unit may be increased compared to previous approaches, since the physical unit is calibrated on the basis of a virtual component, as a result of which it does not have to be removed from a plant for calibration.

In particular, the processor is set up to simulate the virtual component in a cloud environment. This enables decentralized access to the virtual component, so that the simulation topology can be used for the calibration of different physical units.

The verification unit may coordinate the calibration and/or adjustment of the physical unit.

For this purpose, the verification unit may be designed as a stand-alone service in the simulation topology, for example within the cloud, on a server, or on an edge device.

Alternatively, the verification unit may also be designed as a software module and/or hardware module in a control center coupled to the physical unit or the plant in which the physical unit is provided.

In principle, it is possible for the virtual component and the virtual environment, i.e., the virtual process environment and/or the virtual laboratory environment, to be a simulation. This means that the virtual measured values corresponding to the set values for the physical unit may be simulated for the past, the present, and/or the future.

The compensation data and/or the reference compensation data may be determined using artificial intelligence.

### BRIEF DESCRIPTION OF THE DRAWINGS

The claimed subject matter and further advantageous embodiments and further developments thereof are described and explained in more detail below with reference to the examples shown in the drawings, in which:

FIG. 1 shows a system according to an embodiment of the present disclosure for calibrating and adjusting a physical unit,

FIG. 2 shows a further system according to an embodiment of the present disclosure for calibrating and adjusting a physical unit, and

FIG. 3 shows an overview of a method according to an embodiment of the present disclosure of calibrating a physical unit.

### DESCRIPTION OF THE DRAWINGS

All features mentioned below in relation to the example embodiments and/or the accompanying figures can be combined alone or in any sub-combination with features of the claimed subject matter, including features of preferred embodiments.

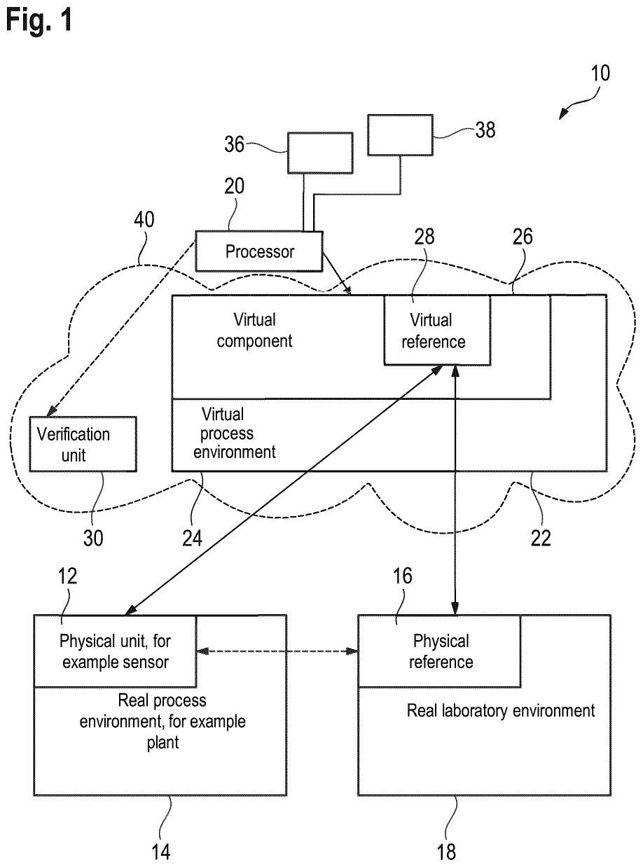

FIG. 1 shows a system 10 for calibrating and adjusting a physical unit 12 according to an embodiment.

The system 10 comprises the physical unit 12, which may include a measuring unit, for example a sensor or a sensor-actuator system.

The physical unit 12 is arranged in a real process environment 14, i.e., implemented in a plant such as a process plant, for example.

A physical reference 16 is assigned to the physical unit 12. The physical reference 16 is arranged in a real laboratory environment 18. In this respect, it is ensured that the physical reference 16 always provides the true values for the physical unit 12. In other words, the physical reference 16 represents a primary reference.

While defined and constant environmental conditions prevail for the physical reference 16 in the real laboratory environment 18, the real process environment 14 has differing and, in particular, varying environmental conditions which affect the operating principle of the physical unit 12. Although the physical unit 12 generally has an operating principle which matches the operating principle of the physical reference 16, the deviating and varying environmental conditions nevertheless result in measured values for the physical unit 12 which deviate from the reference values of the physical reference 16.

In addition, the physical reference 16 differs from the physical unit 12 in that the measurement accuracy of the physical reference 16 is higher than the measurement accuracy of the physical unit 12 by at least a factor of 10. Therefore, the physical reference 16 could be used as a calibration device.

According to the present embodiment, the system 10 comprises a processor 20 which is used to simulate a virtual environment 22.

In the example shown in FIG. 1, the virtual environment 22 corresponds to a virtual process environment 24 through which the real process environment 14 in which the physical unit 12 is arranged is modeled. In particular, the environmental conditions prevailing in the real process environment 14, which may vary, are modeled within the virtual process environment 24.

Furthermore, the processor 20 simulates at least one virtual component 26 which is arranged in the virtual process environment 24. This means that the virtual component 26 is exposed to the varying environmental conditions modeled in the virtual process environment 24. The virtual component 26 is therefore exposed to the environmental conditions to which the physical unit 12 is also exposed, since the virtual process environment 24 is a replica of the real process environment 14.

According to the example embodiment of FIG. 1, the virtual component 26 is a virtual reference 28 which is modeled on the real reference 16 but is arranged in the replica of the real process environment 14, i.e., the virtual process environment 24. The virtual reference 28 is therefore not arranged in a virtual laboratory environment, so that the virtual reference 28 is exposed to conditions other than those of the real reference 16.

Rather, the virtual reference 28 exhibits a behavior in the virtual process environment 24 which corresponds to the physical reference 16 if the latter were arranged in the real process environment 14. In other words, the behavior of the physical reference 16 in a different environment, namely the real process environment 14, is simulated.

Since the real process environment 14 differs from the real laboratory environment 18, for example in terms of environmental conditions, an environment offset is produced, which is taken into account so that the virtual reference 28 in the virtual process environment 24 behaves in a manner corresponding to the physical reference 16 in the real process environment 14.

Of course, the virtual reference 28 is formed such that it also has a high degree of accuracy corresponding to the accuracy of the physical reference 16.

In addition, a verification unit 30 is provided, which is provided, for example, by the processor 20, i.e., as a software-based module, which is represented in the present case by the dashed arrow. For example, the verification unit 30 is a service which is executed on the processor 20. Alternatively, the verification unit 30 can be a hardware module which is provided at a specific location, in particular as part of the plant in which the physical unit 12 is implemented, or in a control center.

Since the virtual component 26, i.e., the virtual reference 28, behaves in the virtual process environment 24 in a manner corresponding to the physical reference 16 in the real process environment 14, the virtual component 26 can be used by the verification unit 30 to calibrate the physical unit 12 in the real process environment 14.

The verification unit 30 can optionally first compare the virtual reference 28 with the physical reference 16 to ensure that the virtual reference 28 provides the same values as the physical reference 16 in the same environment, for example in the laboratory environment.

In this respect, the verification unit 30 has access, among other things, to the physical unit 12, the physical reference 16, and the virtual component 26, in particular the respective measured or reference values.

The verification unit 30 can obtain a virtual measured value from the virtual component 26. To this end, the verification unit 30 supplies the respective virtual component 26 with data, or more precisely with input data, from the physical unit 12, i.e., the data on the basis of which the physical unit 12 issues real measured values. Since the virtual process environment 24 is generally formed to correspond to the real process environment 14, a virtual measured value of the virtual component 26 should result ideally, i.e., in the calibrated state of the physical unit 12, which corresponds to the real measured value of the physical unit 12.

An offset between the real measured value (actual value) recorded by means of the physical unit 12 and the virtual measured value (set value) provided by the virtual component 26 is equivalent to a change in the state of the physical unit 12, which results in the physical unit 12 no longer being considered calibrated.

The offset can then be used by the verification unit 30 to determine compensation data to be taken into account when recording future real measured values by the physical unit 12 to adapt the behavior of the physical unit 12 to the behavior of the virtual component 26. This enables calibration of the physical unit 12 without deactivating and/or removing the physical unit 12 from the real process environment 14. An immediate comparison of the physical unit 12 with the physical reference 16 in the real laboratory environment 18 is therefore not necessary.

This can minimize or even completely avoid downtime of the physical unit 12 and the plant in which the physical unit 12 is arranged, so that operational efficiency can be increased.

The system 10 also has at least one user interface 36, which is coupled here at least to the processor 20, since the verification unit 30 is implemented in software. If the verification unit 30 is implemented at least partially in hardware, the user interface 36 can also be provided on the verification unit 30 as an alternative or in addition to the processor 20.

The user interface 36 enables the verification unit 30 to issue notifications to a user of the system 10 or to receive user inputs, for example to specify parameters.

In addition, the system 10 also has at least one data memory 38, which is at least indirectly coupled to the verification unit 30. The compensation data determined by the verification unit 30 can be stored in the data memory 38 so that it can be used by the user or a downstream component, for example an evaluation device, for interpreting the real measured values recorded using the physical unit 12. This prevents the intrinsic parameters of the physical unit 12 from having to be changed. Rather, the compensation data which enables the determined offset to be compensated can be read out of the data memory 38 and taken into account when interpreting the real measured values of the physical unit 12.

Furthermore, FIG. 1 shows that the virtual environment 22 and the verification unit 30 are simulated in a cloud environment 40. In this respect, the processor 20 can be part of a server.

Alternatively, the processor 20 can be provided in an edge device.

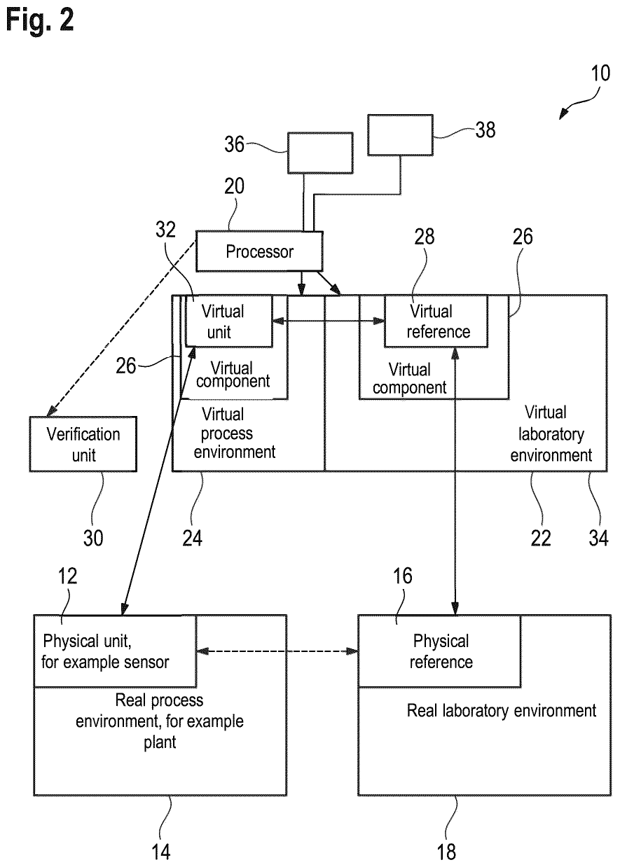

FIG. 2 shows an example embodiment of the system 10, in which the virtual environment 22 differs from the virtual environment 22 of FIG. 1 in that the virtual component 26 is now a virtual unit 32 which is formed to correspond to the physical unit 12. The virtual unit 32 is arranged in the virtual process environment 24.

In addition, the virtual environment 22 of FIG. 2 differs from the virtual environment 22 of FIG. 1 in that an additional virtual laboratory environment 34 is simulated by the processor 20 within the virtual environment 22. The virtual laboratory environment 34 is formed to correspond to the real laboratory environment 18.

In this case, the processor 20 can simulate, in addition to the virtual unit 32, a further virtual component 26 in the form of a virtual reference 28, which is assigned to the virtual unit 32 and arranged within the virtual laboratory environment 34. The virtual reference 28 is formed to correspond to the physical reference 16.

According to the specific design of the virtual environment 22 of FIG. 2, each physical component, i.e., the physical unit 12 and the physical reference 16, has a digital twin assigned thereto, namely the virtual unit 32 and the virtual reference 28.

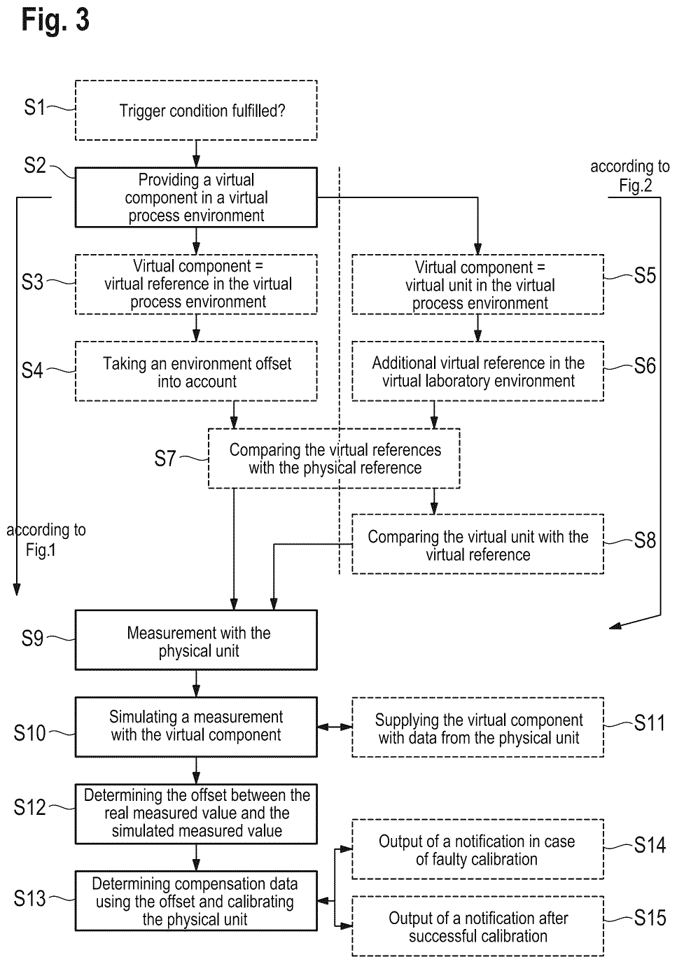

The differences between the two systems 10 become apparent from FIG. 3, which shows an overview of a method of calibrating a physical unit 12. Optional steps are shown in dashed lines.

In a first step S1, the verification unit 30 checks whether a trigger condition for the method is fulfilled, i.e., whether calibration of the physical unit 12 is to be triggered using the virtual component 26.

The trigger condition can be based on the fact that a regular, predeterminable time interval has elapsed, i.e., it can be time-based. The predeterminable time interval can be specified by a user of the system 10, for example, using the user interface 36.

Alternatively, the trigger condition can be determined in an event-based manner using a difference threshold value. In this case, the verification unit 30 repeatedly determines the offset between the real measured value recorded using the physical unit 12 and the virtual measured value simulated using the virtual component 26 and compares the offset with the difference threshold value. If the offset determined in this way is greater/less (depending on the sign) than the difference threshold value, the trigger condition may be fulfilled. Of course, the difference threshold value can be specified by a user of the system 10, for example using the user interface 36.

In a further alternative, the trigger conditions can also be triggered in an event-based manner immediately as a result of a user input via the user interface 36. The trigger conditions can also be fulfilled in an event-based manner by a trigger signal from a further component, for example a higher-level control device.

In the next step S2 of the method, the virtual component 26, which is formed in the virtual process environment 24, is provided.

The virtual component 26 can be implemented in two different ways.

According to step S3, the virtual component 26 is a virtual reference 28 formed in the virtual process environment 24, as shown in FIG. 1. The virtual reference 28 is formed in the virtual process environment 24 so as to model the physical reference 16 assigned to the physical unit 12. Thus, while the physical reference 16 is arranged in the real laboratory environment 18, the virtual reference 28 is arranged in the virtual process environment 24 in this case.

Accordingly, step S3 can be further developed by step S4, in which the behavior of the physical reference 16 in the real process environment 14 is simulated by the virtual reference 28 in the virtual process environment 24. To enable this, an environment offset reflecting the difference between the real process environment 14 and the real laboratory environment 18 can in particular be taken into account by the verification unit 30 as part of step S4.

As an alternative to steps S3 and S4, the virtual component 26 may also be formed as a virtual unit 32 in step S5 following step S2, which is arranged in the virtual process environment 24, as shown in FIG. 2.

The virtual unit 32 is simulated by the processor 20 such that it is set up to be of the same type as the physical unit 12. Since the virtual process environment 24 is modeled on the real process environment 14, the virtual unit 32 in the virtual process environment 24 therefore behaves in a manner corresponding to the physical unit 12 in the real process environment 14. The virtual unit 32 is also referred to as the digital twin of the physical unit 12.

According to this configuration of the virtual environment 22, the processor 20 can simulate a virtual reference 28 in accordance with step S6, which is arranged in a virtual laboratory environment 34. The virtual laboratory environment 34 is modeled on the real laboratory environment 18. The virtual reference 28 is formed to correspond to the physical reference 16. As a result, the virtual reference 28 behaves in the virtual laboratory environment 34 in a manner corresponding to the physical reference 16 in the real laboratory environment 18. The virtual reference 28 is also referred to as digital twin of the physical reference 16.

Based on the different configurations of the virtual environment 22 according to steps S4 or S6, the method then comprises the following step S7.

In step S7, the verification unit 30 compares the virtual reference 28 with the physical reference 16. The environment of the virtual reference 28 must be taken into account here. The physical reference 16 is in any case arranged in the real laboratory environment 18. However, the virtual reference 28 can be arranged either in the virtual process environment 24 (steps S3 and S4 according to FIG. 1) or in the virtual laboratory environment 34 (steps S5 and S6 according to FIG. 2). Consequently, depending on the configuration, an environment offset must be taken into account when comparing the virtual reference 28 with the physical reference 16.

In a configuration of the virtual environment 22 in which no virtual reference 28 is provided, but only a virtual unit 32 arranged in the virtual process environment 24, through which the virtual component 26 is formed (i.e., without step S6), the verification unit 30 compares the respective virtual unit 32 with the physical reference 16. Since the virtual unit 32 is arranged in the virtual process environment 24, an environment offset must also be taken into account, which reflects the differences between the real process environment 14 and the real laboratory environment 18.

If the virtual environment 22 has both a virtual unit 32 and a virtual reference 28, the method may comprise, following step S7, step S8, in which the verification unit 30 compares the virtual unit 32 with the virtual reference 28. The verification unit 30 then takes into account that the virtual unit 32 is arranged in the virtual process environment 24, while the virtual reference 28 is arranged in the virtual laboratory environment 34. In this respect, an environment offset can also be taken into account here.

Depending on the configuration of the virtual environment 22, step S9 follows step S7 or step S8. In step S9, a measurement is performed using the physical unit 12 to obtain a real measured value. The measurement can be performed or at least triggered by the verification unit 30.

In step S10, the verification unit 30 then simulates a measurement with the virtual component 26 in the virtual process environment 24 to obtain a virtual measured value. Of course, a virtual measured value is obtained from the verification unit 30 such that it is corresponding to the recorded real measured value from the previous step S9.

Step S10 can be further developed by step S11, in which the verification unit 30 supplies the virtual component 26 with data from the physical unit 12 to obtain the virtual measured value. This means that the verification unit 30 uses the input data or input signals of the physical unit 12 to supply the virtual component 26 with the same data and to obtain the virtual measured value based on this data.

Following step S10, the method comprises step S12, in which the verification unit 30 determines an offset based on a comparison of the real measured value obtained in step S9 and the virtual measured value obtained in step S10.

In the subsequent step S13, the verification unit 30 determines any compensation data for future measured values of the physical unit 12 based on the determined offset. The determined compensation data is then used by the verification unit 30 to compensate the physical unit 12. The compensation data can also be used for past measured values of the physical unit 12, i.e., retrospectively.

This means that future real measured values recorded using the physical unit 12 and/or already obtained measured values are calibrated (retrospectively) using the compensation data. This ensures the reliability of the recorded real measured values. In particular, this enables calibration of the physical unit 12 without having to remove it from the real process environment 14 and compare it with the physical reference 16.

Preferably, the verification unit 30 can output the determined compensation data for a user or store it for other components, for example in the data memory 38.

The method can also be further developed by optional step S14, in which the verification unit 30 issues a notification or message in the event of an incorrect calibration.

The notification can be output to the user by the verification unit 30 using the user interface 36. Alternatively, a message in the form of a signal can be provided to other components using a communication interface to enable (partially) automated further processing. The message can be output by the verification unit 30 to an external component, such as a control center of the plant of which the physical unit 12 is a part.

In particular, calibration is faulty if:
the verification unit 30 determines that, after determining corresponding compensation data, a non-negligible offset between a newly recorded real measured value and a virtual measured value corresponding thereto is detected again within a specified time interval, and/or
a virtual reference 28 assigned to the physical unit 12 cannot be reached, and/or
a virtual reference 28 assigned to a virtual unit 32 issues an error message, and/or
the virtual unit 32 cannot be reached or does not exist, and/or
the virtual unit 32 issues an error message.

All these events result in that it is not possible to perform a reliable calibration of physical unit 12 that is valid for at least a certain period of time. It must therefore be assumed that the calibration is faulty.

Optionally, in step S14, the verification unit 30 can provide a note within the notification or message issued that the physical unit 12 is to be calibrated with the physical reference 16 and/or that the physical unit 12 is to be adjusted.

However, the method also includes step S15, in which the verification unit 30 issues a notification or message if the calibration of the physical unit 12 is successful. The assumption that the calibration has been successfully completed may be based on the verification unit 30 determining that there is no deviation or only a permissible deviation after calibration has been completed.

In particular, based on the message according to steps S14 and S15, process automation with regard to the physical unit 12, including the calibration thereof, is enabled. In the context of process automation, one of the trigger conditions outlined with regard to step S1 can be taken into account.

The difference between the system 10 shown in FIG. 1 and the system 10 shown in FIG. 2 is reflected in the method in that the virtual unit 32 is constantly calibrated with the virtual reference 28 so that the virtual unit 32 is always in a calibrated state.

If step S12 determines that there is an offset between the virtual unit 32 and the physical unit 12, the virtual unit 32 and the physical unit 12 can be synchronized. This results in calibration, since the virtual unit 32 has already been calibrated using the virtual reference 28.

It is generally provided that the virtual reference 28 is constantly compared with the physical reference 16 to ensure that the true values are always available in the virtual environment 22, by means of which the physical unit 12 is calibrated. This enables the physical unit 12 to be calibrated without removing it from the plant, thereby increasing efficiency accordingly.

1. A method of calibrating a physical unit arranged in a real process environment, wherein the method comprises at least the following steps:
providing a virtual component formed in a virtual process environment, wherein the virtual process environment is formed to correspond to the real process environment so that the physical unit arranged in the real process environment behaves in a manner corresponding to the virtual component in the virtual process environment,
performing a measurement with the physical unit to obtain a real measured value,
simulating a measurement with the virtual component to obtain a virtual measured value,
determining an offset by means of a verification unit based on a comparison of the real measured value and the virtual measured value, wherein the real measured value and the virtual measured value are corresponding, and
calibrating the physical unit by means of the verification unit using the offset at least such that compensation data based on the offset are taken into account for future measured values of the physical unit.

2. The method according to claim 1, wherein the virtual component is a virtual reference which is modeled on a physical reference assigned to the physical unit, wherein the physical reference is arranged in a real laboratory environment, whereas the virtual reference is arranged in the virtual process environment, and wherein the real process environment differs from the real laboratory environment.

3. The method according to claim 2, wherein a behavior of the physical reference in the real process environment is simulated by the virtual reference in the virtual process environment.

4. The method according to claim 1, wherein the virtual component is a virtual unit which is modeled on the physical unit, wherein the virtual unit is formed in the virtual process environment so that the virtual unit formed in the virtual process environment behaves in a manner corresponding to the physical unit arranged in the real process environment.

5. The method according to claim 4, wherein a virtual reference is provided which is modeled on a physical reference assigned to the physical unit, wherein the physical reference is arranged in a real laboratory environment, whereas the virtual reference is arranged in a virtual laboratory environment formed to correspond to the real laboratory environment, and wherein the real process environment differs from the real laboratory environment.

6. The method according to claim 5, wherein the virtual reference in the virtual laboratory environment behaves in a manner corresponding to the physical reference in the real laboratory environment.

7. The method according to claim 5, wherein the verification unit, before calibrating the physical unit by means of the virtual unit, compares the virtual unit with the virtual reference.

8. The method according to claim 5, wherein the verification unit takes an environment offset dependent on the virtual laboratory environment of the virtual reference into account.

9. The method according to claim 1, characterized in that the verification unit calibrates the physical unit with the virtual component if an event-and/or time-based trigger condition is fulfilled.

10. The method according to claim 1, characterized in that the virtual component is supplied with data from the physical unit to obtain virtual measured values.

11. The method according to claim 1, wherein an adjustment of the physical unit is carried out if the calibration of the physical unit still results in an offset.

12. The method according to claim 1, wherein the verification unit issues a notification or a message if a calibration of the physical unit using the virtual component fails.

13. The method according to claim 1, wherein the verification unit issues a notification or a message after successful calibration of the physical unit.

14. The method according to claim 1, wherein the verification unit triggers the calibration of the physical unit with the virtual component:
at regular, predeterminable time intervals, and/or
when the verification unit determines that the offset is greater or less than a predetermined threshold value, and/or
in response to a user input.

15. A system for calibrating and adjusting a physical unit, wherein the system has a real process environment in which the physical unit is arranged, and wherein the system has at least one processor configured to simulate a virtual process environment which is formed to correspond to the real process environment and in which a virtual component is provided, wherein the system is configured to perform the method according to claim 1.
